(19) United States
(12) Patent Application Publication
(10) Pub. No.: US 2024/0288024 A1
(43) Pub. Date: Aug. 29, 2024

(54) SCREW CONNECTION

(71) Applicant: AKO Kunststoffe Alfred Kolb GmbH, Sinsheim-Hoffenheim (DE)

(72) Inventors: Harald Müller, Oftersheim (DE); Lukas Gawron, Helmstadt-Bargen (DE)

(73) Assignee: AKO Kunststoffe Alfred Kolb GmbH, Sinsheim-Hoffenheim (DE)

(21) Appl. No.: 18/589,028

(22) Filed: Feb. 27, 2024

(30) Foreign Application Priority Data
Feb. 28, 2023 (DE) 102023201826.8

(51) Int. Cl. F16B 37/04; F16B 5/02

(52) U.S. Cl. CPC F16B 37/043; F16B 5/0291; F16B 2200/403

(57) ABSTRACT

The invention describes a screw fastening for fixedly joining together two components, and has a first component, which at one edge thereof has a rib-shaped joining region, as well as a joining member, which is arranged fixedly at said joining region, a self-tapping screw and a second component. The second component is joined fixedly to the joining member and the first component by way of this screw. The joining member has a hole along the first component on the first side thereof, and has an abutment portion, which is arranged on a second side, remote from the first side, of the first component. The joining member has a slot-like recess at the abutment portion, through which the first component extends. The hole in the joining member protrudes over the first component, such that the screw screwed thereinto is screwed into the first component in a thread formed by said screw.

### FIELD OF APPLICATION AND TECHNICAL BACKGROUND OF THE INVENTION

The invention relates to a screw fastening for fixedly joining together two components, wherein at least one component is advantageously plate-shaped.

When joining or screwing two components together, in particular two plastics parts, the components may be joined together either using auxiliary elements, such as for example threaded bushes, speed nuts or the like, or in the form of direct screw fastenings using self-tapping or thread-rolling screws screwed into openings or into screw bosses. In the manufacture of screw bosses in particular, problems of ventilation and cooling occur very frequently at the base of the screw boss. This leads to visual faults, such as sink marks and shiny patches on the visible side and/or the back face.

U.S. Pat. No. 3,106,994 A discloses a fastening assembly comprising first and second structural members. The structural members are inclined at an angle toward each other, wherein each of the structural members has an opening. The fastening assembly has a joinery insert with a body sized to be inserted into the opening of the first member, wherein said body has a through-hole which extends parallel to said first member. In addition, the fastening assembly has a screw, which is positioned in the opening of the second member and in the through-hole, wherein the thread of the screw is circumferentially larger than the through-hole. A flange is connected to the body of the joinery insert, wherein said flange entirely covers the opening of the first member when the body is inserted into the opening.

U.S. Pat. No. 5,674,023 A discloses a joint assembly, a first part abutting a surface of a second part. An opening is provided in the first part, which opening is spaced from the surface of the second part. The joint assembly has a clip with two spaced plates connected by a spine. The one plate has a hooked tongue which engages in the opening in the first part. The other plate seats on the second part. Both plates have edges abutting the first part. Through-holes in the plates accept a screw, which holds the clip to the second part and pulls the two parts together.

### Object and Solution

The object of the present invention is to provide a screw fastening which offers advantages over the prior art in particular with regard to structure, manufacturing cost, assembly and disassembly effort, functionality, flexibility, robustness and/or re-usability and in particular is easy to produce and durably robust.

This object is achieved by a screw fastening having the features of claim 1. Advantageous and preferred embodiments of the invention are the subject matter of further claims and are explained in greater detail below. The wording of the claims is incorporated by express reference into the content of the description.

The screw fastening has a first component, which at one edge thereof has a joining region which is at least in places rib-shaped or plate-shaped, a joining member, which is arranged fixedly at the rib-shaped joining region of the first component, a self-tapping or thread-rolling screw and a second component. The second component is joined by way of the screw firmly to the joining member and the first component. The joining member has a hole, which is arranged along the first component on a first side of the first component, and has an abutment portion, which is arranged on a second side, remote from the first side, of the first component.

In the screw fastening according to the invention, the joining member has a recess at the abutment portion, the first component extending through this recess. Furthermore, the hole in the joining member protrudes at least in part over or into the first component, or overlaps it or extends thereover, in such a way that the screw screwed into the hole is screwed into the first component in a thread formed by said screw. In other words, the hole in the joining member extends at least in part over the first component, such that the self-tapping screw cuts partial threads into the first component. This ensures a good hold.

The screw fastening for fixedly joining together two components is preferably undoable. The joining region of the first component is preferably of flat configuration. The joining member is preferably joined firmly, in particular undoably, to the joining region of the first component.

The screw fastening is not limited to a specific screw diameter. For instance, the screw fastening or the joining member may be designed both for screws of small diameter, for example of diameters of less than 3 mm, for screws of medium diameter, for example of diameters of 3 mm to 10 mm, and also for screws of large diameter, for example of diameters greater than 10 mm.

The first component is preferably made from a plastics material, such as for example a thermoplastic or a thermoset. In alternative embodiments, the first component may be made from wood, from a soft metal, such as for example aluminum, zinc or magnesium, or from a hard metal, such as for example steel. The first component is preferably an injection molding.

Such a screw fastening according to the invention is suitable in particular for joining two components at right angles to one another. The joining member allows screw connection at a rib-shaped or plate-shaped joining region of a component, without a receiving bore or the like in the component being needed therefor.

To join two components together, the joining member is firstly placed or slipped onto the first component, in particular at the rib-shaped or plate-shaped joining region thereof, by way of the recess. Then a second component can be placed onto the first component or onto a top of the joining member and screwed together therewith. Then the self-tapping or thread-rolling screw is screwed through the second component into the hole in the joining member. In the process, the screw cuts or rolls in a thread or partial thread at least in the joining region of the first component. In preferred embodiments, the screw cuts or rolls in a thread or a partial thread only in the joining region of the first component. The inside of the hole in the joining member here serves as a type of abutment for the screw, such that the thread of the screw is formed or cut or rolled to the greatest extent possible into the first component. In alternative embodiments, the screw additionally cuts or rolls a thread into the joining member. Since the screw is in form-locking connection simultaneously with the first component and the joining member via the cut or rolled thread, a fixed and secure screwed connection can be ensured.

In one further development of the invention, the hole in the joining member protrudes by at least 5%, preferably by at least 10%, of the diameter of the hole over or into the first component, in particular by up to 30% or by up to 35%. This constitutes a structurally and functionally advantageous configuration regarding the strength of the screw fastening. The degree of overlap or of intersection between the hole in the joining member and the first component preferably corresponds substantially to one thread depth of the screw. The screw may even engage or cut into the first component as deep as up to its screw core. The diameter of the screw may correspond to the diameter of the hole, wherein the thread of the screw is preferably formed only in the first component. In alternative embodiments, the hole in the joining member abuts the first component. In this case, the diameter of the screw is larger than the diameter of the hole, such that the thread of the screw is formed or cut at least into the first component.

In one further development of the invention, the screw engages in the first component within or along the hole. This constitutes a structurally and functionally advantageous configuration of the screw fastening. This additionally makes it possible for the tip or the end and the thread of the screw to be accommodated wholly in the joining member, resulting in an advantageous configuration from both a safety and a design perspective. The screw engages in the first component preferably along the entire hole. In alternative embodiments, the screw engages in the first component outside the hole, in particular downstream of the hole in the screw-in direction.

In a further development of the invention, the first component has a receiving recess at the edge, into which recess the joining member is inserted in such a way that it is offset further away from the edge toward the face of the first component. This constitutes a structurally and functionally advantageous configuration of the screw fastening, in that the joining member may thereby be attached to the first component in a form-locking manner at the exact position provided therefor. An end face of the joining member, through which the hole extends, is preferably flush with an end face of the first component. This makes it possible to place the second component directly onto the first component or the end face of the joining member or to attach it there.

In one further development of the invention, the joining member has a supporting element at least on one side of the recess, which supporting element abuts one side of the first component. This constitutes a structurally and functionally advantageous configuration of the screw fastening, in particular with regard to the robustness of the screw fastening. This is because the additional lateral support additionally secures the joining member against torsion and/or deformation on screwing in of the screw, in particular in the event of high tightening torques. The supporting element abuts against both sides of the first component in the manner of a clamp. As a result, a distance between the two mutually facing inner clamp faces corresponds to a thickness of the first component in the joining region, such that the clamp faces abut the first component in form-locking manner.

In one further development of the invention, the recess in the joining member overlaps the hole in the joining member at least in part. This constitutes a structurally and functionally advantageous configuration of the joining member, since the strength and robustness of the screw fastening is further improved thereby. This enables the hole in the joining member to protrude over or into the first component. In alternative embodiments, the recess in the joining member directly abuts the hole in the joining member.

In a further development of the invention, a width of the recess in the joining member corresponds to a thickness of the first component in the joining region. This constitutes a structurally and functionally advantageous configuration of the joining member, since the joining member can be placed form-lockingly or with an exact fit onto the first component in the correct position.

In one further development of the invention, the hole in the joining member is a through-hole open at both ends. This constitutes a configuration of the joining member which is advantageous both structurally and above all from a manufacturing perspective. The joining member is thereby usable for screws with different lengths, without adaptation of the joining member being necessary. Alternatively, the hole in the joining member is a blind hole closed at one end.

In a further development of the invention, the joining member is made of a plastics material. This constitutes a configuration of the joining member which is inexpensive and advantageous from a manufacturing perspective. The joining member is preferably an injection molding. The joining member is preferably made of a fiber-reinforced plastics material, wherein the plastics material is, for example, reinforced with glass fibers. In alternative embodiments, the joining member may be made from a metal, for example from steel or cast iron.

In a further development of the invention, the joining member is of U-shaped configuration. In this case, one side of the U-shaped joining member has the hole for the screw, and the other side has the abutment portion or corresponds thereto. This constitutes a structurally and functionally advantageous configuration of the joining member. This makes it possible to displace the joining member in the joining region of the first component along one edge thereof and to align the joining member in accordance with a hole in the second component provided for screw fastening of the second component. In alternative embodiments, the joining member is configured as a box or block or is closed at the side.

In one further development of the invention, the second component is a bell-shaped attachment, which is joined to a third component. This constitutes a structurally and functionally advantageous configuration of the screw fastening. In this case, the third component preferably has a hole, into which the bell-shaped attachment is inserted in particular pressed, in form-locking manner The third component is then joined to the first component or the joining member by way of the bell-shaped attachment. To this end, the bell-shaped attachment has a hole corresponding to the hole in the joining member. In an alternative embodiment, the second component is of plate-shaped configuration. In this case, the second component preferably has a hole, through which the screw is screwed into the joining member, so joining the second component firmly to the first component. The first component may be flat or plate-shaped, preferably at least in the region of the screw fastening.

In one structurally advantageous embodiment, a rib-like tongue is formed in the joining region of the first component by two parallel slots, onto which rib-like tongue the joining member is placed so as to completely surround said rib-like tongue. This constitutes a structurally and functionally advantageous configuration of the screw fastening. In this case, the joining member preferably has joining ribs joined to the abutment portion, which extend, preferably form-lockingly, into the slots.

These and further features are revealed in the description and in the drawings as well as in the claims, wherein the individual features can each be realized singly or severally in the form of sub-combinations in one embodiment of the invention and in other fields, and can represent embodiments advantageous and protectable per se, for which protection is claimed here. The subdivision of the application into individual sections and sub-headings does not limit the general validity of the statements made thereunder.

### BRIEF DESCRIPTION OF THE DRAWINGS

The drawings illustrate advantageous embodiments of the invention. These and further embodiments of the invention are explained in greater detail below. In the figures:

FIG. 1 is a perspective view obliquely from above and behind onto a screw fastening according to the invention with two fixedly joined components and a first embodiment of a joining member, wherein a second component is a bell-shaped attachment,

FIG. 2 is a sectional view along a line II-II in FIG. 1,

FIG. 3 is a sectional view along a line III-III in FIG. 2,

FIG. 4 is a perspective view obliquely from above and the front onto a screw fastening with two fixedly joined components and a second embodiment of a joining member, wherein the second component is a bell-shaped attachment,

FIG. 5 is a perspective view obliquely from above and behind onto the screw fastening of FIG. 4,

FIG. 6 is a sectional view along a line VI-VI in FIG. 5,

FIG. 7 shows the screw fastening of FIG. 5, wherein the joining member is inserted into a beveled receptacle in the first component,

FIG. 8 is a sectional view along a line VIII-VIII in FIG. 7,

FIG. 9 is the sectional view of FIG. 3, wherein a third component is joined to the bell-shaped second component,

FIG. 10 is the sectional view of FIG. 3, wherein the second component is of plate-shaped configuration,

FIG. 11 is a sectional view along a line XI-XI in FIG. 10,

FIG. 12 a sectional view along a line XII-XII in FIG. 10,

FIG. 13 a perspective view obliquely from below onto a third embodiment of a joining member and

FIG. 14 is a perspective view obliquely from above onto the joining member of FIG. 13.

### DETAILED DESCRIPTION OF THE EXEMPLARY EMBODIMENTS

As is illustrated in the figures on the basis of a plurality of exemplary embodiments, the screw fastening according to the invention is configured for fixedly joining together two components 1, 2, preferably at right angles. To this end, the screw fastening comprises a first component 1, which at least in places has a rib-shaped or plate-shaped joining region 3 at one edge 14 thereof, a joining member 4, which is arranged fixedly on the joining region 3 of the first component 1, a self-tapping or thread-rolling screw 5 and a second component 2. Overall, the component 1 is flat or plate-shaped, although it does not necessarily have to be completely planar everywhere and may also otherwise be curved. The second component 2 is bell-shaped and joined fixedly to the joining member 4 and the first component 1 by way of the screw 5. It so to speak generally stands for a second component.

The joining member 4 has a hole 6, which is arranged along or parallel to the first component 1 on a first side 7 of the first component 1. Moreover, it has an abutment portion 8, which is arranged on a second side 9 of the first component 1 remote from the first side 7, as shown for example in FIG. 3. The joining member 4 is joined preferably fixedly, in particular also undoably, to the joining region 3 of the first component 1.

In the screw fastening according to the invention, the joining member 4 has a recess 10 at the abutment portion 8, wherein the first component 1 extends through the recess 10, as is illustrated in particular in FIG. 3. The hole 6 in the joining member 4 protrudes at least in part over or into the first component 1, or extends thereover, in such a way that the screw 5 screwed into the hole 6 is screwed into the first component 1 in a thread 11 formed or cut by said screw 5, as is shown in particular in FIGS. 3 and 12. In the process, the screw 5 cuts or rolls partial threads into the first component 1.

In the embodiments shown, the first component 1 is made from a plastics material, such as for example a thermoplastic or a thermoset. In alternative embodiments, the first component 1 may be made from wood, from a soft metal, such as for example aluminum, zinc or magnesium, or from a hard metal, such as for example steel. In any event, the materials for the first component 1 and for the screw 5 should be selected such that the screw 5 can, as described, cut or roll partial threads into the first component 1. The first component 1 is preferably an injection molding.

To assemble or join the two components 1, 2 together, the joining member 4 is firstly placed or slipped onto the first component 1, in particular at the joining region 3, by way of the recess 10. The first component 1 thus extends in the slot-like recess 10. The second component 2 can then be placed onto the first component 1 or onto a top or end face 13 of the joining member 4, and screwed thereto or joined with the screw fastening according to the invention. The screw 5 is then screwed through the second component 2 into the hole 6 in the joining member 4. In the process, the screw 5 cuts or rolls a thread 11 in one outer side of the first component 1, at least in the joining region 3 of the latter. In the embodiments shown, the screw 5 cuts or rolls a thread 11 only in the joining region 3 of the first component 1. The inside of the hole 6 in the joining member 4 here serves as a type of abutment for the screw 5, such that the thread of the screw 5 is formed or cut to the greatest extent possible into the first component. In alternative embodiments, the screw 5 additionally cuts or rolls a thread into the joining member 4. In this way, it may overall form a more robust joint, and above all these partial threads, which extend over far more than half the circumference of the screw 5, may also give said screw 5 a firmer hold.

In one structurally advantageous embodiment, the hole 6 in the joining member 4 protrudes by at least 5%, preferably by at least 10%, of the diameter D_{B} of the hole 6 over the first component 1, as is shown in particular in FIG. 12. In this case, it protrudes by somewhat less than 20%. The extent of an overlap Ü between the hole 6 in the joining member 4 and the first component 1 preferably corresponds substantially to a thread depth of the screw 5, the screw 5 thus here being able to cut in as far as its screw core.

In the embodiments shown, the diameter D_{S} of the screw 5 corresponds to the diameter D_{B} of the hole 6, as illustrated in particular in FIG. 3. As a result, the thread of the screw 5 preferably merely engages in the first component 1. In alternative embodiments, the hole 6 in the joining member 4 abuts the first component 1. In this case, the diameter D_{S} of the screw 5 is greater than the diameter D_{B} of the hole 6, such that, when the screw 5 is screwed in, the thread thereof is formed or cut into the first component 1.

In one structurally advantageous embodiment, the screw 5 engages within or along the hole 6 in the first component 1, as shown in FIGS. 3, 9 and 10. In the embodiments shown, the screw 5 is wholly accommodated in the joining member 4, as shown in particular in FIGS. 3 and 4.

In a method which is not shown, the screw 5 engages along the entire hole 6 in the first component 1. In further embodiments which are not shown, the screw 5 engages in the first component 1 outside the hole 6, in particular downstream of the hole 6 in the screw-in direction.

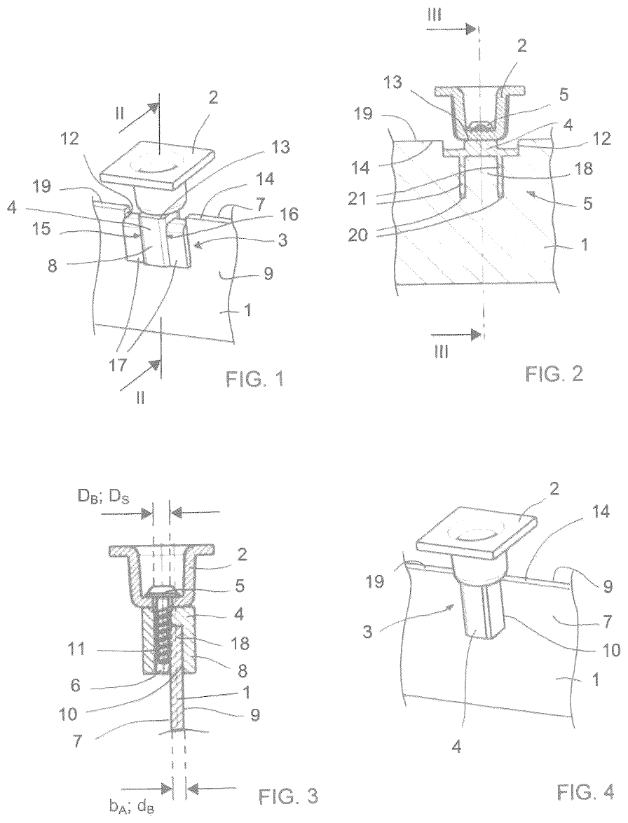

In one advantageous configuration, the first component 1 has a receiving recess 12 at the edge 14, into which recess 12 the joining member 4 is inserted in such a way that it is offset further away from the edge 14 toward the face of the first component 1, as shown in FIGS. 1 and 2. As a result, an end face 13 of the joining member 4, through which the hole 6 extends, is flush with an end face 19 of the first component 1, as shown in FIG. 6. In this embodiment, the second component 2 lies directly on the first component 1 or the end face 13 of the joining member 4.

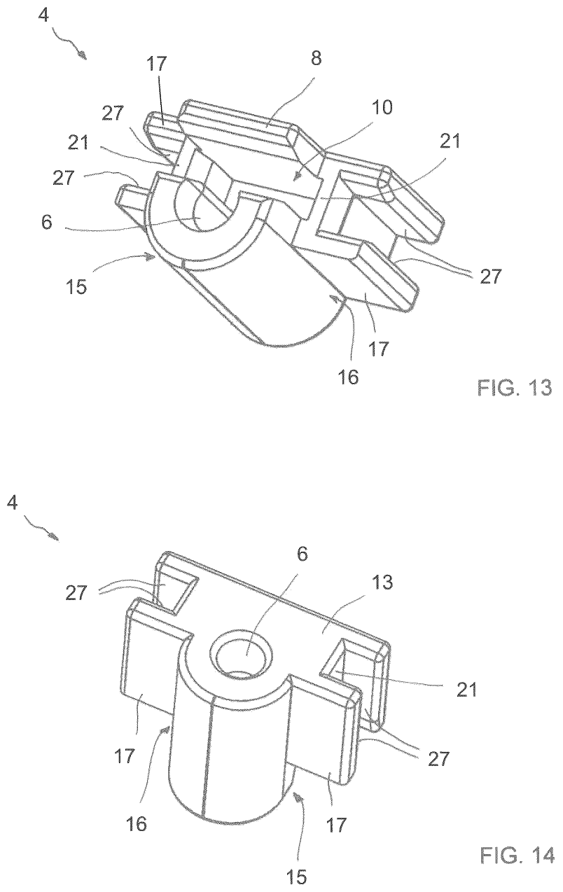

In advantageous embodiments, the joining member 4 has a supporting element 17 at least on one side 15, 16 of the recess 10, which supporting element abuts one side 7, 9 of the first component 1, as shown in FIG. 1. The supporting element 17 functions as an additional lateral support and secures the joining member 4 against torsion and/or deformation on screwing in of the screw 5, in particular in the event of high tightening torques at the screw 5. In the embodiment shown in FIG. 1, the supporting element 17 abuts the two sides 7, 9 of the first component 1 in the manner of a clamp. As a result, a distance between the two mutually facing inner clamp faces 27, as shown in FIGS. 13 and 14, corresponds to a thickness de of the first component 1 in the joining region 3. In this way, the clamp faces 27 abut the first component 1 in form-locking manner and ensure a robust joint.

In one structurally advantageous method, the recess 10 of the joining member 4 at least in part overlaps with the hole 6 in the joining member 4, as shown in particular in FIG. 13.

In one embodiment which is not shown, the recess 10 of the joining member 4 directly abuts the hole 6 in the joining member 4.

In one advantageous configuration, a width b_{A} of the recess 10 of the joining member 4 corresponds to a thickness d_{B} of the first component 1 in the joining region 3, as shown in FIG. 3. In this way, the joining member 4 is or may be placed form-lockingly or with an exact fit onto the first component 1.

In one further structurally advantageous method, the hole 6 in the joining member 4 is a through-hole open at both ends, as shown in FIGS. 3, 9 and 10.

In one embodiment which is not shown, the hole 6 in the joining member 4 is a blind hole closed at one end, in particular the opposite end from the end face 13.

In advantageous embodiments, the joining member 4 consists of a plastics material. In this case, the joining member 4 is preferably an injection molding. The joining member 4 is preferably made from a fiber-reinforced plastics material, wherein the plastics material is, for example, reinforced with glass fibers. In alternative embodiments, the joining member 4 is made from a metal, for example from steel or cast iron.

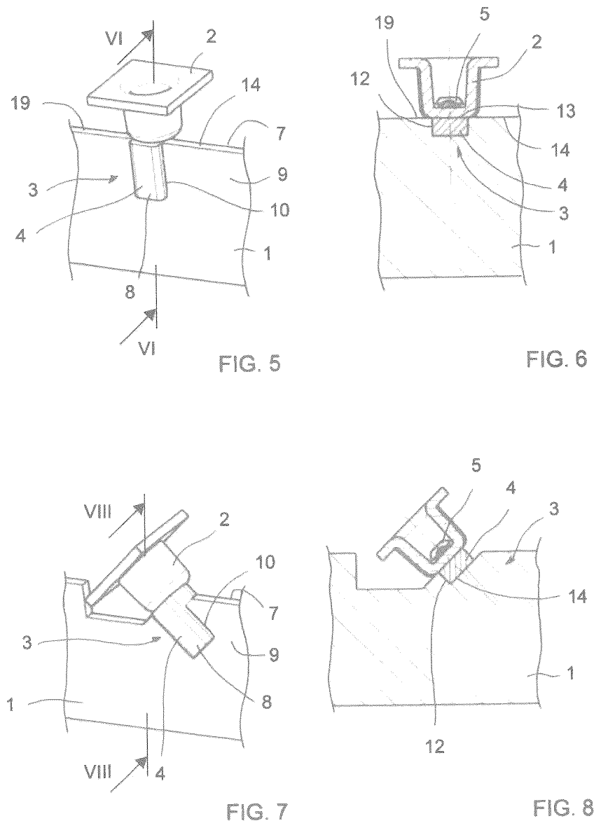

In one structurally advantageous embodiment, the joining member 4 is of U-shaped configuration. In this case, one side of the joining member 4 has the hole 6 for the screw 5 and the other side has the abutment portion 8 or corresponds thereto, as shown in particular in FIGS. 3 to 5. In the embodiment according to FIGS. 13 and 14, the joining member 4 is configured as a box or block or is closed at the side.

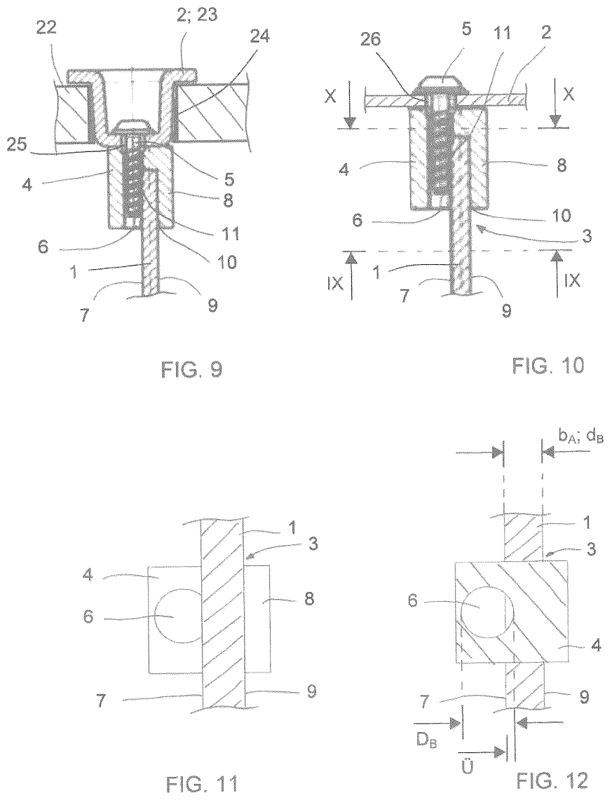

In advantageous embodiments, the second component 2 is a bell-shaped attachment 23, which is joined to a third component 22, as shown in FIG. 9. To this end, in the embodiment shown the third component 22 has a hole 24, into which the bell-shaped attachment 23 is form-lockingly inserted. The third component 22 is joined to the first component 1 or to the joining member 4 by way of the bell-shaped attachment 23. To this end, the bell-shaped attachment 23 has a hole 25 corresponding to the hole 6 in the joining member 4.

In the embodiment shown in FIG. 10, the second component 2 is of plate-shaped configuration. In this case, the second component 2 preferably has a hole 26, through which the screw 5 is screwed into the joining member 4, so joining the second component 2 firmly to the first component 1.

In one structurally advantageous embodiment, a rib-like tongue 18 is formed in the joining region 3 of the first component 1 by two parallel slots 20, onto which rib-like tongue 18 the joining member 4 is placed so as to completely surround said rib-like tongue 18, as shown in FIG. 2. The joining member 4 extends, with joining ribs 21 joined to the abutment portion 8, form-lockingly into the slots 20, as shown in FIGS. 2 and 13.

As is clear from the exemplary embodiments illustrated and mentioned above, the invention provides a screw fastening which offers advantages over conventional screw fastenings or indeed other clamped connections, in particular with regard to structure, manufacturing cost, assembly and disassembly effort, functionality, flexibility, robustness and/or re-usability.

1. A screw fastening for fixedly joining together two components, wherein said screw fastening has:
a first component, which at least in places has a rib-shaped joining region at one edge thereof,
a joining member, which is arranged fixedly on said rib-shaped joining region of said first component,
a self-tapping screw,
a second component, which is joined firmly to said joining member and said first component by way of said self-tapping screw,
wherein said joining member has a hole, wherein said hole is arranged along or parallel to said first component on a first side of said first component, and
wherein said joining member has an abutment portion, wherein said abutment portion is arranged on a second side, remote from said first side, of said first component,
wherein
said joining member has a recess at said abutment portion and said first component extends through said recess,
said hole in said joining member protrudes at least in part over said first component, such that said screw screwed into said hole is screwed into said first component in a thread formed by said screw.

2. The screw fastening according to claim 1, wherein said hole in said joining member protrudes by at least 5% of a diameter of said hole over or into said first component.

3. The screw fastening according to claim 2, wherein said hole in said joining member protrudes by up to 35% of a diameter of said hole over or into said first component.

4. The screw fastening according to claim 1, wherein said screw engages within or along said hole in said first component.

5. The screw fastening according to claim 4, wherein said screw engages along said entire hole in said first component.

6. The screw fastening according to claim 1, wherein said first component has a receiving recess at said edge, wherein said joining member is inserted into said recess in such a way that said joining member is offset further away from said edge toward a face of said first component.

7. The screw fastening according to claim 6, wherein an end face of said joining member, through which said hole extends, is flush with an end face of said first component.

8. The screw fastening according to claim 1, wherein said joining member has a supporting element at least on one side of said recess, wherein said supporting element abuts one side of said first component.

9. The screw fastening according to claim 8, wherein said supporting element abuts said two sides of said first component in a manner of a clamp.

10. The screw fastening according to claim 1, wherein said recess of said joining member overlaps said hole in said joining member at least in part.

11. The screw fastening according to claim 1, wherein a width of said recess in said joining member corresponds to a thickness of said first component in said joining region.

12. The screw fastening according to claim 1, wherein said hole in said joining member is a through-hole open at both ends.

13. The screw fastening according to claim 1, wherein said joining member consists of a plastics material.

14. The screw fastening according to claim 13, wherein said joining member is a plastics injection molding.

15. The screw fastening according to claim 1, wherein said joining member is of U-shaped configuration.

16. The screw fastening according to claim 1, wherein said second component is a bell-shaped attachment joined to a third component.

17. The screw fastening according to claim 1, wherein said second component is of plate-shaped configuration.

18. The screw fastening according to claim 1, wherein said first component is of plate-shaped configuration.

19. The screw fastening according to claim 1, wherein a rib-like tongue is formed in said joining region of said first component by two parallel slots, wherein said joining member is placed onto said rib-like tongue so as to completely surround said rib-like tongue.

20. The screw fastening according to claim 19, wherein said joining member extends with joining ribs joined to said abutment portion into said two parallel slots.
